(19) United States
(12) Patent Application Publication
(10) Pub. No.: US 2010/0254519 A1
(43) Pub. Date: Oct. 7, 2010

(54) VOICE-RECORDABLE VOCAL EMERGENCY NOTIFICATION SYSTEM

(76) Inventor: Chien-Chung Su, Taichung City (TW)

Correspondence Address: APEX JURIS, PLLC, 12733 LAKE CITY WAY NORTHEAST, SEATTLE, WA, 98125, US

(21) Appl. No.: 11/961,652

(22) Filed: Dec. 20, 2007

(51) Int. Cl. H04M 11/04

(52) U.S. Cl. 379/37

(57) ABSTRACT

The present invention discloses a voice-recordable vocal emergency notification system, wherein the user can store his own vocal emergency message in the system. In the present invention, the vocal emergency message, which may be recorded by the user himself, is input into the system via a communication module. A memory module is used to store and play the vocal emergency message. The communication module sends the vocal emergency message to the police according to the notification telephone numbers, and the case-reporting system of the police can thus receive clear information about the case. Then, the police verify with the GPS service company the user's data and obtain the position of the user. Thereby, the police can fast execute a rescue action.

### FIELD OF THE INVENTION

The present invention relates to an emergency notification system, particularly to a system which utilizes a telecommunication device to send a vocal emergency message to the police station in an emergency.

### BACKGROUND OF THE INVENTION

At present, most of GPS (Global Positioning System) application systems apply to the US Positioning Service Company for dedicated lines of navigation service. The GPS system is realized by 24 satellites orbiting in the outer space and transmitting positioning data with two dedicated frequencies of 1227.6 MHz and 1575.4 MHz. The GPS technology is usually used in the dispatching, monitoring and theft-prevention of vehicles. For example, a vehicle theft-prevention device usually uses the bidirectional SMS (Short Message Service) of a wireless telecommunication system to far-end monitor and control a vehicle. A conventional vehicle theft-prevention device usually comprises: a vehicle-end server, a far-end monitoring server and a wireless communication system. The notification system of the abovementioned vehicle theft-prevention device enables the monitoring server to achieve the GPS surveillance applications, such as the functions of security, personnel surveillance and vehicle surveillance.

There are always various accidents in daily living. Further, public security is also deteriorating. However, the best a conventional vehicle theft-prevention device can do is merely to make the personnel on the monitoring-server side able to track the vehicle. The police are notified by the personnel on the monitoring-server side. A realtime emergency notification needs telephoning. However, it is impossible for a mute person, or a person unable to move freely, to notify the police with voice. In such cases, tragedies may thus occur.

Science and technology should be made the best of to improve living environment. Accordingly, the present invention proposes an effective approach to solve an accident or disaster in a shortest time.

### SUMMARY OF THE INVENTION

One objective of the present invention is to provide a voice-recordable vocal emergency notification system, which utilizes a communication device to send a vocal emergency message to the police in an emergency, whereby the vocal emergency message recorded by the user himself can be realtime sent to the case-reporting system of the police, and whereby the time to verify the case and confirm the identity can be minimized, and whereby the rescue action can be instantly executed.

To achieve the abovementioned objective, the present invention proposes a voice-recordable vocal emergency notification system, which can performs surveillance and sends out a vocal emergency message, wherein the user can record his own vocal emergency message. The voice-recordable vocal emergency notification system of the present invention comprises: a switching element used to trigger the emergency notification system; a microprocessor triggered by the switching element to execute programs and control peripheral devices; a GPS receiver module controlled by the microprocessor to receive the coordinate signals sent out by the satellites of the GPS system; a communication module controlled by the microprocessor to communicate with the external, receive the voice signals of wireless communication and storing the notification telephone numbers (preferably the case-reporting telephone numbers of the local police organization); and a memory module electrically coupled to the communication module and controlled by the microprocessor to store a vocal emergency message coming from the communication module. Thereby, the communication module can call to the notification telephone numbers and send out the recorded vocal emergency message when an emergency occurs.

The microprocessor is connected to a pickup device and thus can directly record a vocal emergency message. Alternatively, the microprocessor is connected with a transmission interface, and a voice file containing a vocal emergency message can thus be transmitted into the microprocessor via the transmission interface. The transmission interface may be a standard serial port (such as RS232, RS485 or RJ45) or a Universal Serial Bus (USB).

The communication module may be a GSM (Global System for Mobile communication) system, whereby the voice-recordable vocal emergency notification system can be applied to a mobile object. Alternatively, the communication system may be a wired telephone, whereby the voice-recordable vocal emergency notification system can integrate with a nursing system for patients or in-house elders.

A mute person, or a person unable to move freely, can use the present invention to directly notify the police of an emergency incident via triggering the present invention. Further, the user himself can record his own vocal emergency message to provide clear information for the case-reporting system of the police. Then, the police verify the user's data with the GPS service company and obtain the positional information. Thereby, the police can reduce the search area and accelerate the rescue action.

### BRIEF DESCRIPTION OF THE DRAWINGS

FIG. 1 is a block diagram schematically showing a voice-recordable vocal emergency notification system according to the present invention.

### DETAILED DESCRIPTION OF THE PREFERRED EMBODIMENTS

Below, the embodiments are described in detail to demonstrate the technical contents of the present invention. However, it should be noted that the embodiments are only to exemplify the present invention but not to limit the scope of the present invention.

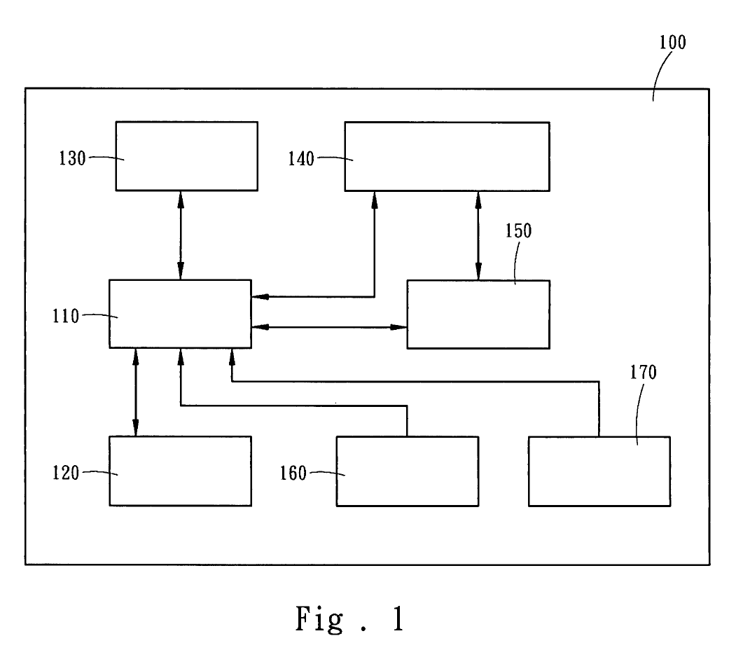

Refer to FIG. 1 a block diagram schematically showing a voice-recordable vocal emergency notification system according to the present invention. The voice-recordable vocal emergency notification system 100 of the present invention comprises: a switching element 120, a microprocessor 110, a GPS receiver module 130, a communication module 140, and a memory module 150.

The switching element 120 is used to trigger the vocal emergency notification system 100. When there is an emergency condition, for example, a condition that a burglar breaks into the user's car, or a condition that the user has an accident and is unable to move freely, or a condition that a chronic illness recurs to the user, or a condition that the user is a solitary elder and has an accident, or a condition that a burglar breaks into the user's house, pressing the switching element 120 can instantly trigger the vocal emergency notification system 100 of the present invention. Alternatively, when an emergency or abnormal condition occurs, the switching element 120 can be driven to trigger the vocal emergency notification system 100 by a sensor, which is connected to a related notification system or surveillance system.

The microprocessor 110 is triggered by the switching element 120 and used to execute related programs and control peripheral devices.

The GPS receiver module 130 is controlled by the microprocessor 110 to receive the coordinate signals sent out by the satellites of the GPS system. The GPS receiver module 130 can also encode and send out the coordinate signals at a specified timing or when a monitoring center queries.

The communication module 140 is controlled by the microprocessor 110 to communicate with the external and stores the notification telephone numbers, preferably the case-reporting telephone numbers of the local police organization. The vocal emergency message recorded by the user himself can be realtime sent to the case-reporting system of the police. Thereby, the time to verify the case and confirm the identity can be minimized, and the necessary rescue measures can be instantly executed. The communication module 140 may be a GSM (Global System for Mobile communication) system, whereby the vocal emergency notification system 100 can be applied to a mobile object, such as a vehicle. Alternatively, the communication system 140 may be a wired telephone, whereby the vocal emergency notification system 100 can integrate with a nursing system for patients or in-house elders.

The memory module 150 is electrically coupled to the communication module 140 and controlled by the microprocessor 110 and stores programs the microprocessor 110 needs. The user may call to the telephone number of the communication module 140; after a password verification procedure, the user can record his own vocal emergency message in the memory module 150 to form a voice file. The communication module 140 can call out to the notification telephone numbers and sends out the vocal emergency message. The memory module 150 can also store the positional coordinates received by the GPS receiver module 130 and record the travel path of a vehicle.

The microprocessor 110 is connected to a pickup device 160 and thus can directly record a vocal emergency message. Alternatively, the microprocessor 110 is connected with a transmission interface 170. The transmission interface 170 may be a standard serial port (such as RS232, RS485 or RJ45) or a Universal Serial Bus (USB). A general voice file containing a vocal emergency message, such as that recorded with a general recording device, may be converted into a voice file with the format required by the memory module 150. Then, the voice file is stored into the memory module 150 via the transmission interface 170. Thereby, the vocal emergency message can be easily recorded and updated.

The content of the vocal emergency message relies on the application condition and is recorded in the memory module 150 beforehand. When the present invention is applied to a vehicle, the identification number, style and color of the vehicle and the data of the owner will be included in the vocal emergency message. When a burglar breaks into the vehicle, or when the user has an accident and is unable to move freely, the police can quickly grasp the condition. Then, the police verify with the GPS service company the user's data and obtain the position of the vehicle. Thereby, the police can reduce the search area and fast execute a rescue action.

When the present invention is applied to a patient or a solitary elder, the telephone numbers of medical organizations will be recorded in the communication module 140, the personal data, address and diseases of the user will be included in the vocal emergency message. When a burglar breaks into the residence, or when the user has an accident and is unable to move freely, the police or the medical organization verify with the GPS service company the user's data and obtain the position of the vehicle. Thereby, the police or the medical organization can fast execute a rescue action.

The preferred embodiments described above are only to exemplify the present invention but not to limit the scope of the present invention. Any equivalent modification or variation according to the spirit of the present invention is to be also included within the scope of the present invention.

What is claimed is:

1. A voice-recordable vocal emergency notification system, which is used to monitor and vocally notify of an emergency, comprising:
a switching element used to trigger said vocal emergency notification system;
a microprocessor triggered by said switching element and used to execute programs and control peripheral devices;
a GPS receiver module controlled by said microprocessor to receive positional coordinate signals sent out by satellites of the GPS (Global Positioning System) system;
a communication module controlled by said microprocessor to communicate with the external and receive voice signal of wireless communication and storing notification telephone numbers; and
a memory module electrically coupled to said communication module, controlled by said microprocessor to store a voice file containing a vocal emergency message coming from said communication module, and sending said vocal emergency message to said notification telephone numbers.

2. The voice-recordable vocal emergency notification system according to claim 1, wherein said microprocessor is connected to a pickup device and thus can directly record a vocal emergency message.

3. The voice-recordable vocal emergency notification system according to claim 1, wherein said microprocessor is connected to a transmission interface to receive and record an external voice file having a vocal emergency message.

4. The voice-recordable vocal emergency notification system according to claim 3, wherein said transmission interface is a standard serial port or a Universal Serial Bus.

5. The voice-recordable vocal emergency notification system according to claim 1, wherein said communication module is a GSM (Global System for Mobile communication) system.

6. The voice-recordable vocal emergency notification system according to claim 1, wherein said communication module is a wired telephone.
